(19) United States
(12) Patent Application Publication
(10) Pub. No.: US 2024/0248949 A1
(43) Pub. Date: Jul. 25, 2024

(54) OPTIMIZATION CONTROL APPARATUS, OPTIMIZATION CONTROL METHOD, AND PROGRAM

(71) Applicant: Hitachi, Ltd., Tokyo (JP)

(72) Inventor: Katsuhiro Takahashi, Tokyo (JP)

(21) Appl. No.: 18/485,647

(22) Filed: Oct. 12, 2023

(30) Foreign Application Priority Data
Jan. 19, 2023 (JP) 2023-006382

(51) Int. Cl. G06F 17/11

(52) U.S. Cl. CPC G06F 17/11

(57) ABSTRACT

An optimization control apparatus includes an optimization database that stores solutions of an annealing apparatus that solves a combinatorial optimization problem by optimization processing that uses an annealing method; and an optimization control unit that sets a weight to a constraint of the combinatorial optimization problem, causes the annealing apparatus to execute the optimization processing, detects the constraint broken by the optimization processing based on the solution stored in the database, inputs to the annealing apparatus again the combinatorial optimization problem for which the weight for the broken constraint has been changed, repeatedly performs the processing of causing the annealing apparatus to execute the optimization processing, and obtains a solution at which the constraint that is not broken achieves a target satisfaction rate.

### BACKGROUND OF THE INVENTION

### 1. Field of the Invention

The present invention relates to an optimization control apparatus, an optimization control method, and a program.

### 2. Description of the Related Art

In recent years, a method for solving a combinatorial optimization problem using a quantum computer by an annealing method has been studied. Such a method is called quantum annealing. There are various methods of quantum annealing, and the applicants have developed Complementary Metal-Oxide-Semiconductor (CMOS) annealing. CMOS annealing is one of pseudo quantum computing techniques, and is used as a solver for solving an optimization problem (mathematical formula). Specific examples of the optimization problem are assumed as work shift optimization, financial portfolio optimization, and the like.

Here, the work shift optimization will be cited as an example. For example, a constraint is that “the number of monthly working days of personnel A is 15 to 20 days”, and a rule that needs to be followed to solve a problem is referred to as a constraint. Furthermore, a state where a shift generated as an optimization result by an annealing apparatus that performs quantum annealing keeps the above number of days is referred to as “a state where the constraint is kept”. Although a condition of the number of working days differs for each of a large number of personnel, processing of obtaining a solution that simultaneously satisfies various constraints such as working hours, the number of consecutive working days, the number of paid vacations, requests for daily shifts, and restrictions on selectable shifts is referred to as “optimization processing”.

A technique disclosed in WO 2022/024329 A1 to solve a combinatorial optimization problem is known. This WO 2022/024329 A discloses “an optimization apparatus that can reflect in the combinatorial optimization problem a priority of a user for each constraint condition imposed on the combinatorial optimization problem”.

### SUMMARY OF THE INVENTION

Although a solution for solving the combinatorial optimization problem by the annealing method can solve a large-scale problem at a high speed, the number of types of constraints constituting the problem also increases. As the number of types of constraints increases, the number of weights associated with each constraint also increases, and the number of combinations of weights for obtaining an optimal solution becomes enormous. Here, the weight is a parameter for keeping a constraint by the optimization processing, and a constraint that has been applied a great weight becomes difficult to be broken by the optimization processing.

Although, when, for example, the combination problem becomes large-scale, the number of constraints becomes enormous, a user needs to set various parameters including weights to each one of the constraints. An annealing apparatus has characteristics that the annealing apparatus is good at “satisfying all constraints as much as possible”, that is, at a state that cannot be helped even when there is a constraint to be broken, but is not good at, for example, “keeping a constraint A at all times”. Therefore, the user needs to set the weight taking the characteristics of the annealing apparatus into account. For example, since the constraint A is important, as a result of increasing the weight of the constraint A, another constraint B that needs to be kept may not be kept.

However, since there is a limit to manually adjusting multiple weights, there has been conventionally no choice but to take measures of managing a plurality of constraints with a common weight. In this case, although the number of combinations decreases, there has been a probability that an optimal solution cannot be found. In addition, although there may be conceived a method for automatically adjusting weights targeting at all constraints using the Nelder-Mead method, there has been a problem that it takes too much time to obtain a solution when the number of constraints is large.

The present invention has been made in view of such a situation, and an object of the present invention is to shorten a time taken until an optimization control apparatus that solves a combinatorial optimization problem by an annealing method obtains a solution from an annealing apparatus.

An optimization control apparatus according to the present invention includes: a database that stores a solution of an annealing apparatus that solves a combinatorial optimization problem by optimization processing that uses an annealing method; and an optimization control unit that sets a weight to a constraint of the combinatorial optimization problem, causes the annealing apparatus to execute the optimization processing, detects the constraint broken by the optimization processing based on the solution stored in the database, inputs to the annealing apparatus again the combinatorial optimization problem for which the weight for the broken constraint has been changed, repeatedly performs the processing of causing the annealing apparatus to execute the optimization processing, and obtains a solution at which the constraint that is not broken achieves a target satisfaction rate.

According to the present invention, by repeating weight adjustment and optimization processing until a target satisfaction rate can be achieved, it is possible to shorten a time taken until a solution at which a constraint is not broken as much as possible is obtained.

Problems, configurations, and effects other than the above problem, configuration, and effect will be made apparent from the following embodiments.

### BRIEF DESCRIPTION OF THE DRAWINGS

FIG. 1 is a hardware and functional configuration diagram illustrating a configuration example of a problem solving system according to a first embodiment of the present invention;

FIG. 2 is a block diagram illustrating an internal configuration example of an optimization control unit according to the first embodiment of the present invention;

FIG. 3 is a view illustrating a flow of data of each apparatus in the problem solving system according to the first embodiment of the present invention;

FIG. 4 is a view illustrating an example of a variable list according to the first embodiment of the present invention;

FIG. 5 is a view illustrating an example of a constraint list according to the first embodiment of the present invention;

FIG. 6 is a view illustrating an example of a post-processing result list according to the first embodiment of the present invention;

FIG. 7 is a view illustrating an example of a pre-processing result list according to the first embodiment of the present invention;

FIG. 8 is a view illustrating an example of conventional optimization processing of manually adjusting a weight of a constraint;

FIG. 9 is a view illustrating an example of the conventional optimization processing of automatically adjusting a weight of a constraint;

FIG. 10 is a flowchart illustrating an example of processing of the problem solving system according to the first embodiment of the present invention;

FIG. 11 is a flowchart illustrating an example of processing where a weight change unit 2 selects an initial value of a weight according to the first embodiment of the present invention;

FIG. 12 is a view illustrating a configuration example of a problem list screen according to the first embodiment of the present invention; and

FIG. 13 is a flowchart illustrating an example of processing of a problem solving system according to a second embodiment of the present invention.

### DESCRIPTION OF THE PREFERRED EMBODIMENTS

Hereinafter, modes for carrying out the present invention will be described with reference to the accompanying drawings. In the present description and the drawings, components having substantially the same functions or configurations will be assigned the same reference numerals, and redundant description will be omitted.

### First Embodiment

### <Configuration Example of Problem Solving System>

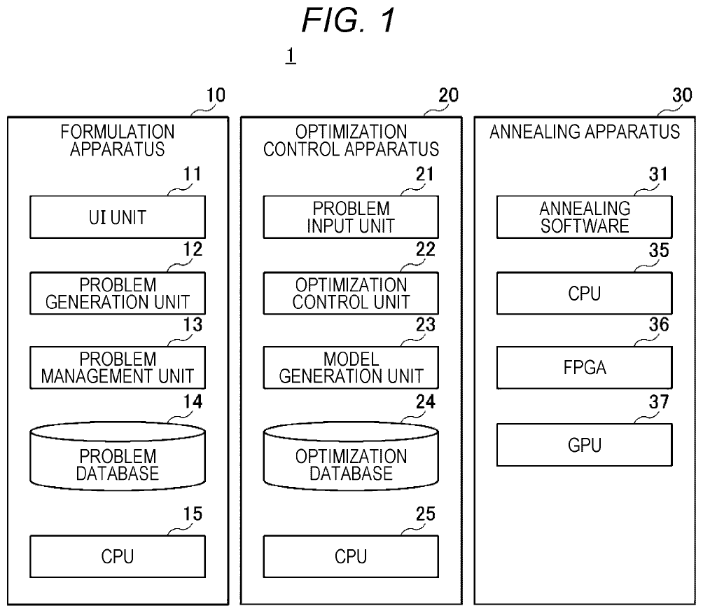

FIG. 1 is a hardware and functional configuration diagram illustrating a configuration example of a problem solving system 1 according to the first embodiment. This problem solving system 1 is a system that finds an optimal solution to an input combinatorial optimization problem by an annealing method that uses CMOS annealing and outputs this optimal solution. Note that the best solution obtained by the annealing method is referred to as an exact solution. Furthermore, a solution that is not an exact solution, but satisfies a constraint as much as possible is referred to as an optimal solution.

The problem solving system 1 includes a formulation apparatus 10, an optimization control apparatus 20, and an annealing apparatus 30. Note that general Personal Computers (PC) or the like may be used as the formulation apparatus 10 and the optimization control apparatus 20.

### <Configuration Example of Formulation Apparatus>

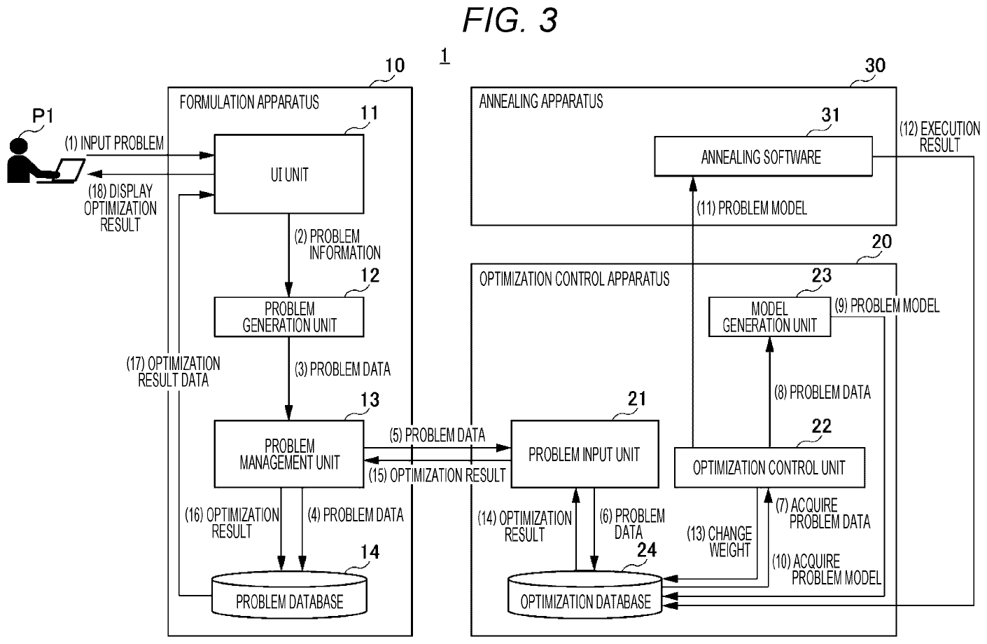

The formulation apparatus 10 is an apparatus that a user P1 (e.g., a system engineer) illustrated in FIG. 3 to be described later operates to input a combinatorial optimization problem. The combinatorial optimization problem is abbreviated as a “problem” in the following description in some cases. A plurality of the formulation apparatuses 10 may be provided according to a type of a problem. In a case where, for example, the user P1 considers optimization of a work shift as a problem, the formulation apparatus 10 for inputting a combinatorial optimization problem of the work shift is prepared. Furthermore, in a case where the user P1 considers optimization of a financial portfolio as a problem, the formulation apparatus 10 for inputting a combinatorial optimization problem of the financial portfolio is prepared. The following description will exemplify a configuration and processing of the problem solving system 1 for obtaining a solution from the optimization problem of the work shift.

The formulation apparatus 10 includes a user interface unit 11 (hereinafter, referred to as the UI unit 11), a problem generation unit 12, a problem management unit 13, a problem database 14, and a Central Processing Unit (CPU) 15.

The UI unit 11 is a component that serves as an interface of the user P1 who uses the formulation apparatus 10, and has a function of accepting an input of a problem and displaying an optimal solution received from the optimization control apparatus 20. Furthermore, a problem input screen and, in addition, a screen that displays an optimization result of the problem obtained by the annealing apparatus 30 are also displayed on the UI unit 11. The UI unit 11 outputs raw data received from the user P1 as problem information to the problem generation unit 12.

The user P1 inputs a constraint of the number of personnel who is work shift targets and working hours desired by the personnel via the UI unit 11. An example of the constraint is information such as available working times of personnel 1 and personnel 2, and days of a week or times during which the personnel 1 and the personnel 2 cannot work a shift at the same time in a case of, for example, a combination of shifts of the personnel 1 and the personnel 2. Note that a problem is input to the UI unit 11 by a method where the user P1 directly inputs information and a constraint of personnel via the UI unit 11, and, in addition, by uploading a file or a compressed file in which the information and the constraint of the personnel are described.

The problem generation unit 12 generates problem data obtained by converting the problem information accepted by the UI unit 11 into a format that can be interpreted by the optimization control apparatus 20.

The problem management unit 13 exchanges various data with the optimization control apparatus 20. At this time, the problem management unit 13 transmits the problem data to the optimization control apparatus 20. Furthermore, the problem management unit 13 stores the problem data in the problem database 14 to manage the problem data transmitted to the optimization control apparatus 20.

The problem database 14 stores the problem data transmitted by the problem management unit 13 to the optimization control apparatus 20, and, in addition, stores an optimal solution received by the problem management unit 13 from the optimization control apparatus 20.

The CPU 15 performs control for implementing functions of the formulation apparatus 10. Note that the formulation apparatus 10 also includes an unillustrated Read Only Memory (ROM), Random Access Memory (RAM), non-volatile storage, and the like. The CPU 15 reads from the ROM a program code of software for implementing each function according to the present embodiment, loads the program code to the RAM, and executes the program code. Variables, parameters, and the like generated during computation processing of the CPU 15 are temporarily written in the RAM, and these variables, parameters, and the like are read as appropriate by the CPU 15. The functions of the UI unit 11, the problem generation unit 12, and the problem management unit 13 are implemented by the CPU 15.

Furthermore, for example, a Hard Disk Drive (HDD), a Solid State Drive (SSD), a magnetic tape, a non-volatile memory, or the like is used as the non-volatile storage. An Operating System (OS) and various parameters, and, in addition, a program for causing the formulation apparatus 10 to function are recorded in this non-volatile storage. Programs, data, and the like necessary for the CPU 15 to operate are recorded in the ROM and the non-volatile storage, and the ROM and the non-volatile storage are used as examples of computer-readable non-transitory storage media that store the program executed by the formulation apparatus 10. The problem database 14 is configured in the non-volatile storage.

### <Configuration Example of Optimization Apparatus>

The optimization control apparatus 20 is provided between the formulation apparatus 10 and the annealing apparatus 30, and mediates the annealing apparatus 30 that performs optimization processing on the combinatorial optimization problem input by the formulation apparatus 10. The optimization control apparatus 20 has a function of converting the problem in such a way that the annealing apparatus 30 can interpret the problem. As described above, since the plurality of formulation apparatuses 10 are provided according to a type of problem in some cases, the optimization control apparatus 20 has a function of converting the problem into a general-purpose form.

This optimization control apparatus 20 includes a problem input unit 21, an optimization control unit 22, a model generation unit 23, an optimization database 24, and a CPU 25.

The problem input unit 21 stores in the optimization database 24 the problem data input from the problem management unit 13 of the formulation apparatus 10. Furthermore, when reading an optimization result stored in the optimization database 24, the problem input unit 21 transmits the optimization result to the problem management unit 13. The optimization result is information obtained when the optimization control unit 22 processes an execution result of the optimization processing of the annealing apparatus 30.

The optimization database 24 (an example of a database) stores a solution of the annealing apparatus 30 that solves the combinatorial optimization problem by optimization processing that uses an annealing method. Hence, the optimization database 24 stores the problem data written by the problem input unit 21, and, in addition, stores a problem model generated by the model generation unit 23. Furthermore, the optimization database 24 stores an execution result obtained when an annealing software program 31 executes the problem model, and an optimization result obtained when the optimization control unit 22 processes the execution result. In the following description, the annealing software program 31 is abbreviated as the “annealing software 31”.

The optimization control unit 22 sets a weight to the constraint of the combinatorial optimization problem, and causes the annealing apparatus 30 to execute the optimization processing. Next, the optimization control unit 22 detects a constraint broken by the optimization processing based on the solution (e.g., the execution result) stored in the optimization database 24. Next, the optimization control unit 22 inputs to the annealing apparatus 30 again the combinatorial optimization problem for which the weight for the broken constraint has been changed, and causes the annealing apparatus 30 to execute the optimization processing. Furthermore, the optimization control unit 22 repeatedly performs these processing, and obtains a solution at which an unbroken constraint achieves the target satisfaction rate. The satisfaction rate is a ratio of constraints that are not broken with respect to all constraints. Here, the optimization control unit 22 may detect a constraint that is readily broken based on a history obtained by causing the annealing apparatus 30 to previously execute the optimization processing, and increase the weight for the constraint that is readily broken. Even in a case of the constraint that is readily broken, this processing makes the constraint of a high degree of importance difficult to be broken.

To perform the above-described processing, the optimization control unit 22 reads the problem data from the optimization database 24, passes the problem data to the model generation unit 23, and causes the model generation unit 23 to generate the problem model. Furthermore, the optimization control unit 22 reads the problem model generated by the model generation unit 23 from the optimization database 24, and instructs the annealing software 31 to execute optimization processing of a problem. This instruction is performed when the optimization control unit 22 transmits the problem model to the annealing software 31.

The optimization control unit 22 can efficiently detect a combination of weights satisfying the constraint set to the problem based on the execution result of the annealing software 31. Furthermore, the optimization control unit 22 also has a “function of detecting by an arbitrary method a constraint (initial target) that is readily broken” and a “function of increasing the weight of the constraint”. Details of these functions will be described later.

Consequently, the optimization control unit 22 can determine the constraint broken by the annealing software 31 based on the execution result of the optimization processing of the annealing software 31 read from the optimization database 24. Furthermore, the optimization control unit 22 can perform processing of changing the weight for the broken constraint, and cause the annealing software 31 to execute the problem model again.

Note that the optimization control unit 22 inputs to the annealing apparatus 30 again the combinatorial optimization problem for which the weight has been changed, repeats the processing of causing the annealing apparatus 30 to execute the optimization processing, and detects as a constraint that is readily broken a constraint that the number of times that the constraint has been broken with respect to a total number of times of processing is a predetermined value or more. In a case where, for example, the total number of times of processing is four, a constraint that has been broken three times is detected as a constraint that is readily broken. In this example, the constraint whose ratio of the number of times that the constraint has been broken with respect to the total number of times of processing is 75% or more is a constraint that is readily broken. Furthermore, the optimization control unit 22 sets to 75% a determination threshold for determining a constraint that is readily broken. Note that the determination threshold is set to 75% in an example, and therefore may be set to 60% or may be set to 90% according to contents of the problem. Furthermore, the determination threshold value may be set by the user P1, or may be arbitrarily set based on a history of problems on which the optimization control unit 22 has previously performed optimization processing.

When receiving the problem data from the optimization control unit 22, the model generation unit 23 generates a problem model for solving the problem using the annealing apparatus 30. The problem model includes information on the degree of importance that is necessary for the annealing software 31 to solve the problem. In the present embodiment, this information on the degree of importance is expressed as a weight. The annealing software 31 performs calculation for keeping a constraint having a greater weight than those of other constraints as much as possible. A reason for this is that it is necessary to keep the constraint that has been broken in order for the annealing software 31 to search for a solution that satisfies all constraints as much as possible. Note that, when the optimization control unit 22 further increases the weight of the constraint that has already been kept, there is a secondary effect that a constraint that has been broken by processing performed so far is no longer broken.

The problem model generated by the model generation unit 23 is temporarily stored in the optimization database 24. Hence, the optimization control unit 22 reads the problem model from the optimization database 24, and thereby outputs the problem model to the annealing apparatus 30.

The CPU 25 performs control for implementing the functions of the optimization control apparatus 20. Note that the optimization control apparatus 20 also includes an unillustrated ROM, RAM, non-volatile storage, and the like. The CPU 25 reads from the ROM a program code of software for implementing each function according to the present embodiment, loads the program code to the RAM, and executes the program code. Variables, parameters, and the like generated during computation processing of the CPU 25 are temporarily written in the RAM, and these variables, parameters, and the like are read as appropriate by the CPU 25. The functions of the problem input unit 21, the optimization control unit 22, and the model generation unit 23 are implemented by the CPU 25.

Furthermore, as the non-volatile storage, for example, an HDD, an SSD, a magnetic tape, a non-volatile memory, or the like is used. An OS and various parameters, and, in addition, a program for causing the optimization control apparatus 20 to function are recorded in this non-volatile storage. Programs, data, and the like necessary for the CPU 25 to operate are recorded in the ROM and the non-volatile storage, and the ROM and the non-volatile storage are used as examples of computer-readable non-transitory storage media that store the program executed by the optimization control apparatus 20. The optimization database 24 is configured in the non-volatile storage.

### <Configuration Example of Annealing Apparatus>

The annealing apparatus 30 includes the annealing software 31, a CPU 35, a Field Programmable Gate Array (FPGA) 36, and a Graphics Processing Unit (GPU) 37. A dedicated OS is installed in the annealing apparatus 30, and the OS controls the operation of the annealing software 31.

When receiving the problem model input from the optimization control unit 22 of the optimization control apparatus 20, the annealing software 31 executes optimization processing using the problem model, and outputs an execution result. At this time, the annealing software 31 executes the optimization processing of the problem using the FPGA 36 or the GPU 37 of the annealing apparatus 30. In this regard, this will be described in the following description as that “the annealing software 31 executes the optimization processing”. The annealing software 31 stores the execution result of the optimization processing in the optimization database 24 of the optimization control apparatus 20.

During the optimization processing, a constraint set to the problem model may be broken. The optimization control unit 22 increases a weight of the broken constraint, and causes the annealing software 31 to execute the optimization processing again. Hence, the processing of the optimization control unit 22 and the annealing software 31 is repeated several times.

The CPU 35 performs control for implementing the function of the annealing apparatus 30.

The FPGA 36 is a component used to implement a CMOS annealing machine. By connecting a plurality of the FPGAS 36, it is possible to extend performance of the annealing apparatus 30 according to a scale of the problem.

Similarly to the FPGA 36, the GPU 37 is also a component used to implement a CMOS annealing machine. By connecting a plurality of the GPUs 37 or enhancing performance of the GPUs 37, it is possible to extend performance of the annealing apparatus 30 according to the scale of the problem. The FPGA 36 and the GPU 37 may be used in combination, or one of the FPGA 36 and the GPU 37 may be used.

### <Internal Configuration Example of Optimization Control Unit>

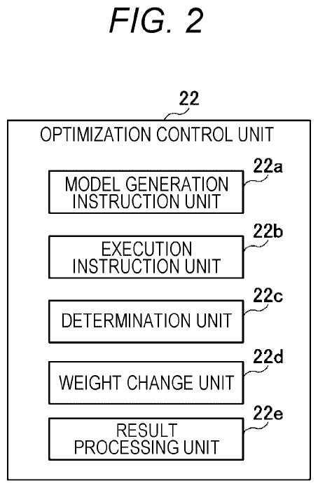

FIG. 2 is a block diagram illustrating the internal configuration example of the optimization control unit 22.

The optimization control unit 22 includes a model generation instruction unit 22a, an execution instruction unit 22b, a determination unit 22c, a weight change unit 22d, and a result processing unit 22e.

The model generation instruction unit 22a instructs the model generation unit 23 to generate a problem model.

The execution instruction unit 22b instructs the annealing software 31 to execute optimization processing that uses the problem model.

The determination unit 22c determines a broken constraint based on the execution result of the optimization processing of the annealing software 31. The execution result of the optimization processing is exemplified in a pre-processing result list of FIG. 7 described later.

The weight change unit 22d performs processing of, for example, increasing the weight for the broken constraint determined by the determination unit 22c, i.e., changing the weight. Note that the weight change unit 22d can also perform processing of decreasing the weight for an unbroken constraint or an unimportant constraint. Furthermore, it is possible to set the number of times of processing of changing the weight, or set a timing to stop the processing of changing the weight. Therefore, the weight change unit 22d does not have to change the weight endlessly, so that it is possible to contribute to shortening a time taken until a solution is obtained.

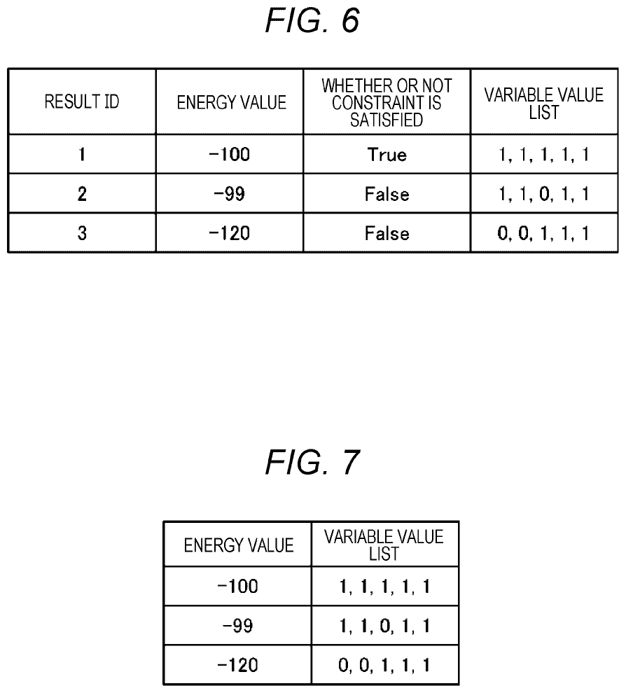

The result processing unit 22e creates an optimization result obtained by processing the execution result of the optimization processing of the annealing software 31, and stores the optimization result in the optimization database 24. The optimization result is exemplified in a post-processing result list of FIG. 6 described later.

### <Description of Flow of Data of Each Apparatus>

Next, processing of each functional unit will be described with reference to FIG. 3 focusing on a flow of data of each apparatus in the problem solving system 1. FIG. 3 is a view illustrating the flow of the data of each apparatus in the problem solving system 1. The arrows indicating the flow of the data will be assigned numbers in parentheses to indicate an order of the flow of the data.

(1) First, the user P1 inputs a problem using the formulation apparatus 10. The user P1 inputs the problem via a screen displayed on a display of the formulation apparatus 10. Furthermore, the UI unit 11 can also read the problem data stored in the problem database 14, and display a previously input problem.

(2) The UI unit 11 converts the problem input by the user P1 into problem information, and outputs the problem information to the problem generation unit 12. This problem information is data in a format that can be displayed on the screen in the UI unit 11.

(3) The problem generation unit 12 generates the problem data converted into a format that the optimization control apparatus 20 can interpret, based on the problem information input from the UI unit 11. Furthermore, the problem generation unit 12 outputs the problem data to the problem management unit 13.

(4) The problem management unit 13 stores the problem data in the problem database 14.

(5) Furthermore, the problem management unit 13 transmits the problem data to the problem input unit 21.

(6) The problem input unit 21 stores the received problem data in the optimization database 24.

(7) The optimization control unit 22 acquires the problem data from the optimization database 24.

(8) Furthermore, the model generation instruction unit 22a of the optimization control unit 22 outputs the problem data to the model generation unit 23, and instructs generation of the problem model.

(9) The model generation unit 23 generates a problem model based on the problem data input from the model generation instruction unit 22a, and stores this problem model in the optimization database 24.

(10) The execution instruction unit 22b of the optimization control unit 22 acquires the problem model from the optimization database 24.

(11) Furthermore, the execution instruction unit 22b of the optimization control unit 22 transmits the acquired problem model to the annealing software 31 of the annealing apparatus 30, and instructs execution of the optimization processing.

(12) The annealing software 31 performs the optimization processing using the problem model, and stores an execution result obtained by this processing in the optimization database 24.

(13) The determination unit 22c of the optimization control unit 22 determines a constraint that has been broken and a constraint that is readily broken based on the execution result read from the optimization database 24. Furthermore, the weight change unit 22d of the optimization control unit 22 performs processing of increasing the weight for the broken constraint. Subsequently, the execution instruction unit 22b instructs the annealing software 31 to execute the optimization processing again.

(14) The problem input unit 21 acquires the optimization result stored in the optimization database 24. Here, the optimization result is data obtained when the result processing unit 22e of the optimization control unit 22 processes the execution result stored in the optimization database 24 from the annealing software 31.

(15) The problem input unit 21 transmits the optimization result acquired from the optimization database 24 to the problem management unit 13.

(16) The problem management unit 13 stores in the problem database 14 the optimization result received from the problem input unit 21. The optimization result stored in the problem database 14 is referred to as optimization result data.

(17) The UI unit 11 acquires the optimization result data from the problem database 14.

(18) The UI unit 11 configures the screen on which the acquired optimization result data is arranged in a layout that the user P1 easily visually checks, and displays the optimization result on the screen.

Consequently, the user P1 can check the optimization result via the UI unit 11.

Here, a combinatorial optimization problem for which optimization processing is performed using the annealing software 31 will be described. Hereinafter, a shift “whose number of monthly working days of the personnel A satisfies the condition, but whose number of consecutive working days is larger than desired” is assumed.

The determination unit 22c increases the weight when, for example, checking “whether or not a shift satisfying the working condition of each personnel has been made”, and detects “a constraint that has been broken by combinatorial optimization” and a “constraint that is readily broken”. Furthermore, in a case where a solution of four consecutive working days is obtained even though the desired number of consecutive working days of the personnel A is three, the constraint on “the number of consecutive working days of the personnel A” is broken. Therefore, even when the optimization processing of the annealing software 31 is executed several times and the solution is obtained, and, when the constraint on the above-described “number of consecutive working days of the personnel A” is broken, the optimization control unit 22 can determine that “the number of consecutive working days of the personnel A” is the “constraint that is readily broken”.

As described above, the weight indicates the degree of importance of the constraint, and is a relative value between the constraints. For example, (constraint A:B:C)=(weight 100:200:300) and (constraint A:B:C)=(weight 1:2:3) have the same meaning. Furthermore, as a result that the annealing software 31 has performed the optimization processing on the problem for which the weight of the constraint has been changed, the constraint that is broken at all times or broken with a probability equal to or more than the determination threshold (e.g., 75%) is referred to as a “constraint that is readily broken”. As described above, the optimization processing is executed four times, and the constraint that has been broken three times is broken at a probability equal to or more than the specified ratio, and therefore is the readily broken constraint.

Next, an advantage obtained by using the annealing method will be described.

Since conventional optimization solvers always keep all constraints, “no solution” is obtained when there is no solution that keep all constraints. In a case where all constraints need to be kept and a problem scale is not so large, it is possible to obtain a solution even when conventional solvers are used. However, the conventional solvers cannot deal with a case where the problem is large and “outputting a solution that meets an expectation as much as possible is permitted”. Compared to the conventional solvers, the annealing method can obtain a “solution that have tried to keep the constraints as much as possible”. Hence, in a case where the problem is large and “outputting a solution that meets the expectation as much as possible is permitted”, the annealing method is effective. Furthermore, according to the annealing method, there is a “constraint that is readily broken”, and the constraint becomes difficult to be broken by adding a weight to this constraint.

Furthermore, according to the annealing method, a solution having a small “energy value” calculated as a result of optimization is regarded as a “better solution”. In this regard, since “there is a probability that a constraint is not kept”, “a solution having the smallest energy value among solutions for which constraints are kept” can be a “better solution”. Consequently, it is also possible to shift to a conventional method for obtaining a “better solution”.

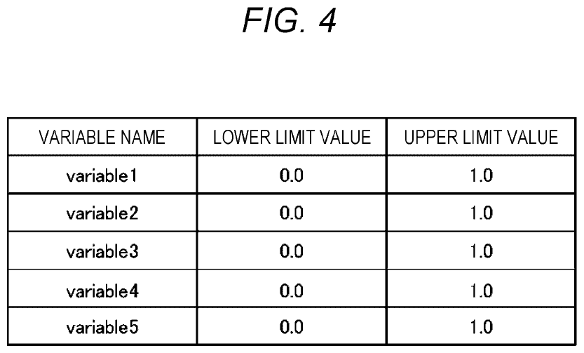

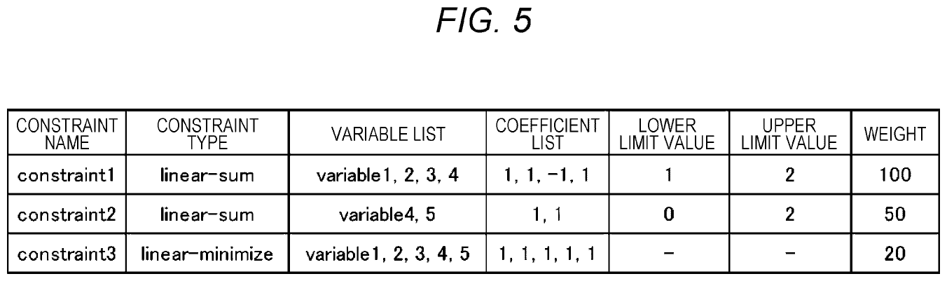

To solve the combinatorial optimization problem, it is necessary to express a problem as the Hamiltonian (energy function) of an Ising model. Hence, a problem is formulated by being expressed by three relationships of an objective function, a decision variable, and a constraint condition. The objective function is a function expressed using a decision variable, and is expressed as a problem model generated by the model generation unit 23 illustrated in FIG. 1. The decision variable indicates as a variable a value that needs to be obtained, and contents of the decision variable is indicated in a variable list illustrated in FIG. 4. The constraint condition expresses as a decision variable a requirement that needs to be kept for the optimization processing of the annealing software 31, and contents of the constraint is indicated in a constraint list illustrated in FIG. 5.

Furthermore, when the annealing software 31 executes the optimization processing, a combination of variables that satisfy the constraint condition and is in a state where energy of the Ising model is low, and that reduce the Hamiltonian is obtained as a solution. According to the annealing method, a solution that does not satisfy the constraint condition can be also obtained in some cases, and the constraint condition that has not satisfied the constraint condition is referred to as that the “constraint has been broken”.

When the annealing software 31 executes the optimization processing of a problem, and thereby a “solution that satisfies all constraints” is found, or when the “set number of times” of the optimization processing ends, all optimization ends. Here, in a case where “the set number of times of optimization ends”, a final result is determined as follows.

(1) Case where there are a Plurality of Solutions Satisfying all Constraints

The determination unit 22c obtains a solution of the smallest energy value calculated by the optimization processing of CMOS annealing as a final result.

(2) Case where No Solution Satisfying all Constraints is not Found

The determination unit 22c obtains a solution of the best score calculated based on an arbitrary condition among found solutions as a solution of the final result. As the final result, for example, a solution of a small energy value, a solution with a smaller number of times that the constraint has been broken, a sum of penalty coefficients for broken constraints, and the like are assumed.

An optimization result obtained when the result processing unit 22e (see FIG. 2) processes the execution result obtained by performing the optimization processing of the annealing software 31 is displayed in a result list illustrated in FIG. 6. Furthermore, an execution result that is the execution result of the annealing software 31 and a pre-processing execution result of the result processing unit 22e is displayed in a result list illustrated in FIG. 7.

Here, various lists used in the present embodiment will be described with reference to FIGS. 4 to 7 citing assignment of work shifts as an example. At a time of assignment of work shifts, for example, it is assumed that there are three shifts (shifts A, B, and C) that can be assigned to three personnel (the personnel 1, the personnel 2, and personnel 3). In a case of the combinatorial optimization problem, for example, a problem of how the work shift on November X, 2022 can be assigned to the personnel 1 is solved. Here, variables indicating the shift A of the personnel 1, the shift B of the personnel 1, and the shift C of the personnel 1 are prepared. Furthermore, the annealing software 31 solves by optimization processing such a problem that a total value of the respective variables becomes “1”. Note that a variable that takes “1” means that the shift indicated by this variable is adopted as the work shift of the personnel 1. By contrast with this, a variable that takes “0” means that the work shift has not been adopted. Therefore, in a case where the variable indicating the shift A of the personnel 1 is “1”, it is found that the shift A has been adopted as the work shift of the personnel 1.

FIG. 4 is a view illustrating an example of the variable list.

In the variable list, variables used for the combinatorial optimization problem are defined. This variable list includes respective items of a variable name, a lower limit, and an upper limit.

A variable name for identifying a variable indicating a shift that can be assigned to each of the above-described personnel is stored in the variable name item.

The lower limit values of the variables are stored in the lower limit value item. A variable that is not adopted as the work shift is “0”.

The upper limit values of the variables are stored in the upper limit value item. A variable that is adopted as the work shift is “1”.

It is assumed that the variable whose variable name illustrated in FIG. 4 is “variable 1” is associated with the shift A of the personnel 1, the variable whose variable name is “variable 2” is associated with the shift B of the personnel 1, and variables are associated with subsequent shifts of the personnel 1 likewise. Note that the variable whose variable name is “variable 4” may be associated with the shift A of the personnel 2, and the variable whose variable name is “variable 5” may be associated with the shift B of the personnel 2. Before the optimization processing is executed, the variables whose variable names are “variable 2” to “variable 5” are included in a range of the lower limit value “0.0” to the upper limit value “1.0”, and are not fixed at “0.0” or “1.0”.

As described above, the variable “1.0” indicates that personnel indicated by this variable adopts the shift, and the variable “0.0” indicates that personnel indicated by this variable does not adopt the shift. Before the annealing software 31 solves a problem by optimization processing, each variable is a number between “0.0” and “1.0”. After the problem is solved, the variable whose variable name is “variable 1” is “1.0”, and the variables whose variable names are “variable 2” to “variable 5” are all “0.0”. In this case, it can be said that the shift A of the personnel 1 indicated by the variable whose variable name is “variable 1” is obtained as the solution. Furthermore, the determination unit 22c of the optimization control unit 22 determines that the constraint is not broken when the solution is included between the lower limit value and the upper limit value, and determines that the constraint has been broken when the solution is not included between the lower limit value and the upper limit value.

FIG. 5 is a view illustrating an example of the constraint list.

In this constraint list, constraints at a time when the variables in the variable list are combined are defined. This constraint list includes respective items of a constraint name, a constraint type, a variable list, a coefficient list, a lower limit value, an upper limit value, and a weight.

Constraint names for identifying constraints to be set to the combinatorial optimization problem are stored in the constraint name item.

Constraint types are stored in the constraint type item. For example, a linear-sum type indicates a constraint that a total value of variables is within a range of the lower limit value and the upper limit value.

A linear-minimize type indicates a constraint that a total value of variables that use the variable list and the coefficient list are minimized as much as possible. Since the constraint of the linear-minimize type does not have the upper limit value and the lower limit value, the constraint is not broken. The constraint of the linear-minimize type is used in a case where, for example, a total value of a certain variable group needs to be made smaller as much as possible while another constraint such as linear-sum is kept.

Combinations of variables selected from the variables listed in the variable list illustrated in FIG. 4 are stored in the variable list item.

A coefficient for each variable stored in the variable list item is stored in the coefficient list item. The coefficient is multiplied on, for example, a plurality of variables.

Lower limit values of calculation results of variables that satisfy constraints are stored in the lower limit value item.

Upper limit values of the calculation results of the variables that satisfy the constraints are stored in the upper limit value item.

A weight set per constraint is stored in the weight item. By setting the weight per constraint, the weight change unit 22d can give greater weights to a constraint that is readily broken and an important constraint than those of other constraints. Furthermore, the weight change unit 22d can set the weight per constraint in accordance with an execution result of optimization processing.

For example, a constraint type whose constraint name is “constraint 1” is “linear-sum”, and therefore is a constraint that a total value obtained by multiplying the variable with the coefficient is in a range from the lower limit value “0” to the upper limit value “2”. Furthermore, the coefficient stored in the coefficient list is multiplied on the coefficient stored in the variable list, and therefore if “variable 1” to “variable 4” are each “1” in an equation of variable 1×1+variable 2×1+variable 3×(−1)+variable 4×1, 1×1+1×1+1×(−1)+1×1=2 holds. As a result, “2” is between the lower limit value “0” and the upper limit value “2”, and therefore it can be said that the variable satisfies the constraint. That is, the variable “1” of “variable 1” to “variable 4” also satisfies the constraint. On the other hand, when “variable 1”, “variable 2”, and “variable 4” are “0” and “variable 3” is “1”, the equation is 0×1+0×1+1×(−1)+0×1=−1. As a result, “−1” is less than the lower limit value “0”, and therefore it can be said that the variable does not satisfy the constraint. In this case, the constraint of “constraint 1” is broken. On the other hand, according to “constraint 2”, when “variable 4” and “variable 5” are “1”, a result obtained by multiplying the variable with the coefficient is “2”, and therefore is the same as the upper limit value “2”, and the variable satisfies the constraint.

Note that the constraint type whose constraint name is “constraint 3” is “linear-minimize”, and therefore is a constraint that the total value of the variables is minimized as much as possible. That is, the constraint of “constraint 3” is that the total value of the equation of variable 1×1+variable 2×1+variable 3×1+variable 4×1+variable 5×1 is minimized as much as possible. As described above, the constraint of the linear-minimize type does not have the upper limit value and the lower limit value, and therefore the constraint is not broken.

Furthermore, as the weight is greater, it is requested more to satisfy the constraint. That is, it can be said that “constraint 1” whose weight is “100” is more strongly requested to satisfy the constraint than “constraint 3” whose weight is “20” is. In other words, “constraint 1” is a constraint that should not be broken, and “constraint 3” is a constraint that may be broken. Note that the weights may take the same numerical value between a plurality of constraints. Consequently, it is possible to preferentially obtain a solution that satisfies the constraint of “constraint 1” of a great weight as much as possible. In this case, a solution that satisfies the constraint of “constraint 1” may not satisfy the constraint of “constraint 3” of a small weight.

Note that a weight increase amount may be changed according to the degree of importance of the constraint. For example, the weight change unit 22d may increase the weight increase amount of “constraint 1” two times, and increase the weight increase amount of “constraint 2” 1.5 times.

FIG. 6 is a view illustrating an example of a post-processing result list.

The post-processing result list indicates, for example, the execution result of the annealing software 31 recorded in a format that the user P1 can check. This post-processing result list includes respective items of a result ID, an energy value, whether or not a constraint is satisfied, and a variable value list.

Result IDs for identifying solutions that are execution results of the annealing software 31 are stored in the result ID item. In this example, it is found that three solutions identified based on result IDs “1” to “3” have been obtained as solutions to the combinatorial optimization problem.

An energy value output by the annealing software 31 for each solution is stored in the energy value item. In general, as the energy value is lower, the better solution is obtained.

Results indicating whether or not the constraint could have been satisfied is stored in the constraint satisfaction item. “True” is stored in a case where the constraint could have been satisfied, and “False” is stored in a case where the constraint could not have been satisfied.

A value of each variable in the variable list illustrated in FIG. 4 is stored as a variable value in the variable value list item. Variable values are stored in the variable value list item in order of “variable 1” and “variable 2” from the top of the variable list.

As illustrated in the post-processing result list, in a case of a variable whose result ID is “1”, and for which “1, 1, 1, 1, 1” is stored in the variable value list item, the constraint satisfaction item is “True”, and therefore indicates that the constraint could have been satisfied. Furthermore, in a case of a variable whose result ID is “2”, and for which “1, 1, 0, 1, 1” is stored in the variable value list item, the constraint satisfaction item is “False”, and therefore indicates that the constraint could not have been be satisfied. On the other hand, although the energy value is “−100” when the result ID is “1”, the energy value is “−120” when the result ID is “3”. However, the constraint satisfaction item is “False” and the result of the result ID “3” cannot satisfy the constraint, and therefore it can be said that a result of the result ID “1” can satisfy the constraint, has a low energy value, and therefore is a good solution. Furthermore, when the annealing software 31 is executed a plurality of times, the constraint can be satisfied, and, when the lowest value of the energy value is output, the solution at this time is obtained as an optimal solution.

FIG. 7 is a view illustrating an example of the pre-processing result list.

The pre-processing result list indicates an execution result at a time of output from the annealing software 31. The pre-processing result list in the format illustrated in FIG. 7 is stored in the optimization database 24.

This pre-processing result list includes respective items of an energy value and a variable value list. Since contents of each item is the same as that of the post-processing result list described with reference to FIG. 6, detailed description thereof will be omitted.

Note that the execution result output by the annealing software 31 does not include the constraint satisfaction item in the post-processing result list illustrated in FIG. 6. After the pre-processing result list illustrated in FIG. 7 is stored in the optimization database 24, the result processing unit 22e reads the pre-processing result list. Furthermore, the result processing unit 22e adds a result ID and a determination result on whether or not the constraint has been satisfied for each execution result based on the contents of the pre-processing result list, and creates a post-processing result list.

### <Description of Conventional Processing (Manual Adjustment)>

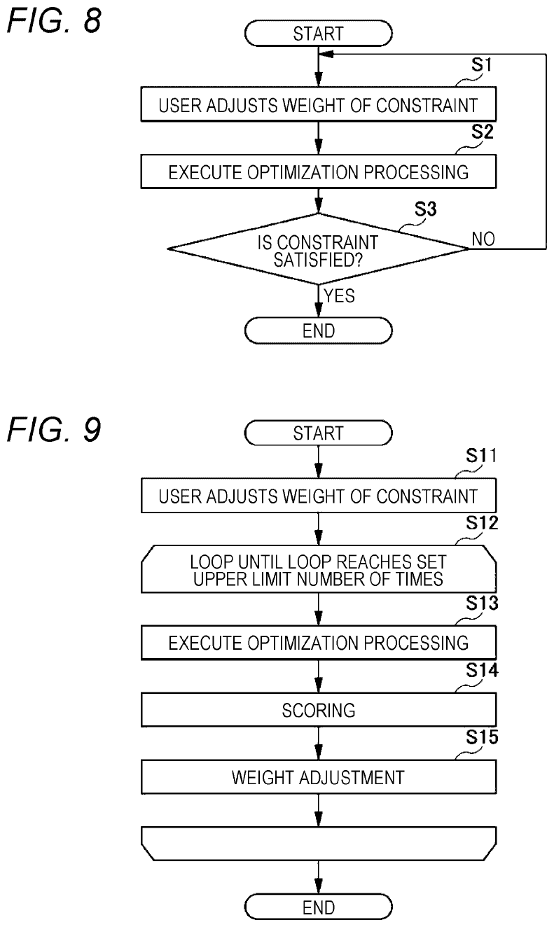

FIG. 8 is a view illustrating an example of conventional optimization processing of manually adjusting a weight of a constraint. Here, processing where the user manually adjusts the weight of the constraint will be described.

First, the user manually adjusts the weight of the constraint per constraint (S1). Next, the user executes optimization processing (S2). At this time, optimization execution processing may be performed using an optimization apparatus (e.g., an annealing apparatus), or the optimization processing may be manually executed while performing visual checking in a case of a small-scale problem.

Next, the user visually determines whether or not the execution result satisfies the constraint (S3). In a case where the execution result does not satisfy the constraint (NO in S3), the processing returns to step S1, and the user readjusts the weight. On the other hand, in a case where the execution result satisfies the constraint (YES in S3), this processing ends.

### <Description of Conventional Processing (Automatic Adjustment)>

FIG. 9 is a view illustrating an example of conventional optimization processing of automatically adjusting a weight of a constraint. Conventionally, a method where the user automatically adjusts a weight of a constraint has been also used.

First, the user adjusts the weight of the constraint (S11). Adjustment of the weight is often manually performed based on a user's past experience.

Next, the conventional optimization control apparatus performs following loop processing until the loop processing reaches a set upper limit number of times (S12). In this loop processing, first, the optimization control apparatus causes the optimization apparatus to perform optimization processing (S13).

Next, the optimization control apparatus performs scoring of scoring the execution result of the optimization apparatus (S14). During the scoring, if a better solution (e.g., a solution having a low energy value) is obtained while the constraint is kept, a score that is a predetermined value is added to an execution result from which this solution has been obtained. Conversely, a penalty (e.g., subtraction of the score) on the execution result is imposed according to the number of constraints that have been broken. Hence, the constraint that has been broken a large number of times is found by the scoring processing in step S14.

Next, the optimization control apparatus adjusts the weight for the constraint (S15). This weight may be adjusted by the user. Subsequently, the processing in and after step S13 is repeated again. Furthermore, when a score higher than that in previous processing can be obtained, the optimization control apparatus obtains as a temporary optimal solution an execution result at a time when the score is obtained. When the loop processing reaches the set upper limit number of times, the optimization control apparatus outputs an execution result of the highest score as an optimal solution.

Note that, according to the conventional processing illustrated in FIGS. 8 and 9, all constraints are satisfied, and then the optimized execution result is obtained. Therefore, when calculation continues until all constraints are satisfied, it takes time until the execution result is obtained, or an optimal execution result cannot be obtained with the set upper limit number of times.

As described above, the number of weights set to the constraint is enormous for the combinatorial optimization problem. To make the user perform manual adjustment, for example, it is possible to classify 10,000 constraints into five categories, and limit the number of types of weights to five. In this case, weights of a plurality of constraints are made the same per category. However, it is not possible to achieve the original purpose of obtaining “a solution that keeps a constraint”.

### <Description of Optimization Control Processing According to Present Embodiment>

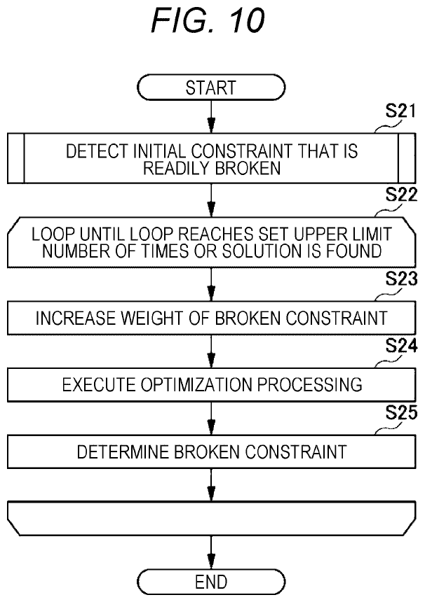

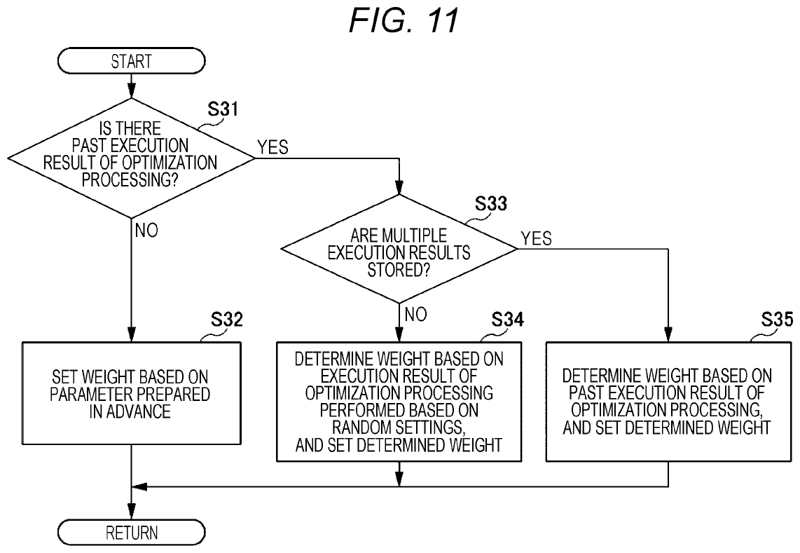

On the other hand, the optimization control apparatus 20 according to the present embodiment does not need to satisfy all constraints. Therefore, the optimization control unit 22 has a function of determining a constraint that is readily broken (initial adjustment target constraint) in accordance with initial optimization processing, increasing the weight of this constraint, and executing the optimization processing. By performing weighting according to the degree of importance of the constraint, the optimization control unit 22 can make the weight of the constraint that cannot be broken and the weight of the constraint that is readily broken different before execution of the optimization processing. Here, examples of processing automatically performed by the optimization control apparatus 20 according to the present embodiment will be described with reference to FIGS. 10 and 11.

FIG. 10 is a flowchart illustrating the example of the processing of the problem solving system 1 according to the first embodiment. This processing is mainly illustrated as an example of an optimization control method for controlling the optimization processing that the optimization control unit 22 causes the annealing software 31 to execute.

First, the weight change unit 22d of the optimization control unit 22 increases the weight of the initial adjustment target constraint based on problem data read from the optimization database 24. The word “initial” means “the first time of a plurality of times of optimization processing” in a case where the optimization control unit 22 executes the plurality of times of optimization processing. Furthermore, the determination unit 22c detects a constraint that is readily broken (S21).

The constraint that is readily broken is an adjustment target to which the weight change unit 22d adds a weight. Before the optimization processing of the annealing software 31 is executed, the weight is adjusted such that the solution readily satisfies the constraint, and therefore it is expected that a better solution is obtained. When the determination unit 22c detects the adjustment target constraint in the processing in step S21, the model generation unit 23 generates the problem model based on the detected constraint, and stores the problem model in the optimization database 24. Subsequently, the optimization control unit 22 and the annealing software 31 start the loop processing in step S22.

Next, the optimization control unit 22 (the execution instruction unit 22b, the determination unit 22c, and the weight change unit 22d) repeats the loop processing until the loop processing reaches the set upper limit number of times or a solution is found (S22). Note that the optimization control unit 22 may repeat the loop processing until the target satisfaction rate is achieved. The target satisfaction rate may be, for example, a condition that 90% or more of constraints of all constraints are not broken.

According to the loop processing starting from step S22, the weight change unit 22d reads the problem model from the optimization database 24, and increases the weight of the constraint broken by the optimization processing of the annealing software 31 (S23). In step S23, the optimization control unit 22 changes the weight change amount per constraint based on the execution result of the optimization processing previously executed by the annealing apparatus 30.

The weight change unit 22d may narrow down constraints for which weights are increased. In a case where the constraint is broken, if it does not matter even when the constraint is broken, the weight change unit 22d does not need to unconditionally increase the weight for this constraint. Hence, the weight change unit 22d changes the weight according to a preset constraint. Furthermore, the weight change unit 22d may arbitrarily determine a target constraint for which the weight is increased.

In this regard, according to the first loop processing, the optimization processing of the annealing software 31 is not yet performed and there is no broken constraint, and therefore the processing in step S23 is not performed, and the processing proceeds to the processing in next step S24.

Next, the execution instruction unit 22b transmits the problem model to the annealing software 31, and causes the annealing software 31 to execute the optimization processing of the problem model (S24). The execution result obtained by optimization performed by the annealing software 31 is stored in the optimization database 24. It is necessary for the optimization processing to prevent the solution from becoming a local optimal solution. The local optimal solution is a solution that is not necessarily the best solution in an entire executable area even if the solution is the best solution near the solution. On the other hand, the best solution in the entire executable area is referred to as a global optimal solution.

Next, the determination unit 22c reads the execution result from the optimization database 24, and determines the constraint broken by the optimization processing (S25). When the determination unit 22c detects a broken constraint, the weight change unit 22d increases the weight for the broken constraint, and adjusts the weight such that the constraint is not broken by next optimization processing.

When, for example, the upper limit number of times is set to 100 times in step S22, after repeating the optimization processing 100 times, the result processing unit 22e processes into an optimization result the execution result from which the best solution has been obtained, and stores this optimization result in the optimization database 24. Alternatively, when an appropriate solution is found, the solution may be stored in the optimization database 24 at this point of time. When this optimization result is read and transmitted by the problem input unit 21 to the problem management unit 13, this optimization result is passed in the format of the post-processing result list illustrated in FIG. 6.

Note that the processing in step S24 is processing for finding the local optimal solution, and the loop processing in step S22 is processing for finding the best solution from some local optimal solutions found in step S24.

FIG. 11 is a flowchart illustrating an example of processing where the weight change unit 22d selects an initial value of a weight. The processing illustrated in FIG. 11 indicates a subroutine in step S21 illustrated in FIG. 10.

First, the weight change unit 22d determines whether or not the execution result of the optimization processing has been previously stored in the optimization database 24 (S31). In a case where the execution result of the optimization processing is not previously stored in the past (NO in S31), the weight change unit 22d sets the initial value of the weight to the constraint based on a parameter prepared in advance (S32), and the processing proceeds to step S22 in FIG. 10. In step S32, the weight change unit 22d sets, for example, weights having the same magnitude to all constraints as initial values. As described above, in step S32, the optimization control unit 22 determines the initial value of the weight based on the parameter prepared in advance, so that it is possible to determine the appropriate initial value of the weight even if there is no past execution result.

On the other hand, in a case where the execution result of the optimization processing has been previously stored (YES in S31), the weight change unit 22d determines whether or not more than a predetermined number of execution results have been accumulated in the optimization database 24 (S33). In a case where multiple execution results are not accumulated in the optimization database 24 (NO in S33), the weight change unit 22d determines an initial value of the weight for the constraint based on the execution result of the optimization processing performed based on arbitrary settings, and sets the determined weight (S34), and then the processing proceeds to step S22 in FIG. 10. As described above, in step S34, by determining the initial value of the weight based on the execution result obtained by causing the annealing apparatus 30 to execute the optimization processing based on the arbitrary settings, the optimization control unit 22 can determine the appropriate initial value of the weight even when the number of accumulated execution results is small.

On the other hand, in a case where multiple execution results are accumulated in the optimization database 24 (YES in S33), it is considered that the past tendency for a certain problem is known. Hence, the weight change unit 22d determines the weight based on the past execution results of the optimization processing, and sets the determined weight (S35), and then the processing proceeds to step S22 in FIG. 10. As described above, in step S35, by determining the initial value of the weight based on the execution result obtained by causing the annealing apparatus 30 to previously execute the optimization processing, the optimization control unit 22 can determine the appropriate initial value of the weight from the execution result having actual achievement.

Here, the processing in FIG. 11 will be described citing the work shift as an example.

A case where there is no execution result of the optimization processing in step S31 is assumed as, for example, a case where, while work shifts of a company A are previously accumulated, work shifts of a company B that is the same industry type as that of the company A are newly created. In this case, the weight change unit 22d refers to the execution result of the optimization processing used when the work shifts of the company A are previously created, and sets a weight to create the work shifts of the company B based on parameters common to the industry type.

Furthermore, a case where multiple past execution results of the optimization processing are not accumulated in step S33 is assumed as a case where the company A has not previously created only work shifts in January and February of a certain year, and a work shift to be created this time is March. In this case, even when the weight change unit 22d determines a weight based on the work shifts of only January and February that are the past execution results of the optimization processing, the weight is likely to be incomplete, and therefore the work shifts of January and February that are the past work shifts are not used to determine the weight. Hence, the weight change unit 22d determines an initial value having the same magnitude as the weight for all constraints.

Furthermore, in step S33, a case where multiple past execution results of the optimization processing are accumulated is assumed as a case where the company A has previously created the work shifts in January, February, . . . , and November of a certain year, and the work shift to be created this time is December. In this case, the weight change unit 22d determines the weight based on the work shifts of January to November that are the past execution results of the optimization processing.

### <Example of Another Method for Detecting Weight Adjustment Target Constraint>

Note that it is not appropriate to take time for processing of detecting a constraint that is readily broken in step S21. If the determination unit 22c can detect the weight adjustment target constraint, it is not necessary to limit the method to the specific method illustrated in FIG. 11. Hereinafter, another method that is performed at a time of start of the optimization processing and detects a weight adjustment target constraint will be described. Examples of this method are supposed to include following first to fourth methods.

### First Method

The execution instruction unit 22b performs control of decreasing the number of times of sweep and causing the annealing software 31 to execute the optimization processing. Furthermore, the determination unit 22c determines the broken constraint as an initial adjustment target. When the execution instruction unit 22b decreases the number of times of sweep, the solution is likely to become a local optimal solution. On the other hand, when the execution instruction unit 22b increases the number of times of sweep, it becomes easy to obtain a “good solution” of a small energy value, but it takes time to obtain a solution.

### Second Method

The execution instruction unit 22b performs control of decreasing the number of times of sweep or decreasing a setting value that is an execution parameter of the annealing software 31, and causing the annealing software 31 to execute a conventional processing flow (automatic adjustment illustrated in FIG. 9 described later). Furthermore, the determination unit 22c determines a constraint that has been broken a large number of times as the initial adjustment target. According to the second method, for example, the execution instruction unit 22b performs control of causing the annealing software 31 to execute the conventional flow (automatic adjustment) three times, and the weight change unit 22d sets to the constraint the weight that has been changed every three times of processing. Furthermore, the determination unit 22c determines that the constraint that has been broken all 3 times is a “constraint that is readily broken”. Furthermore, the execution instruction unit 22b sets this constraint as the initial adjustment target.

Here, the number of times of sweep in the first and second methods will be described. In a specific example, the optimization processing that uses the annealing method corresponds to, for example, “executing optimization while changing a certain temperature parameter (tA) to a certain temperature parameter (tB) several times”. Furthermore, changing the temperature parameter several times is referred to as the number of times of sweep. When the number of times of sweep is large, while there is a low probability that the solution becomes a local optimal solution, and there is a high probability that a better solution is found, it takes time to find a good solution accordingly.

### Third Method

The execution instruction unit 22b sets a weight to an arbitrary constraint, and causes the annealing software 31 to execute the optimization processing. Furthermore, the determination unit 22c determines a broken constraint as an initial adjustment target. Note that, according to the third method, the weight change unit 22d does not change the weight. The execution instruction unit 22b sets the constraint that has been broken even once by the optimization processing as the initial adjustment target, so that it is not necessary to execute the optimization processing over and over again.

### Fourth Method

The execution instruction unit 22b causes the annealing software 31 to execute the optimization processing while changing weights of several patterns for an arbitrary constraint. Furthermore, the determination unit 22c determines a constraint that has been broken a large number of times as the initial adjustment target. Note that, according to the fourth method, the weight change unit 22d changes the weight. For example, the execution instruction unit 22b changes the weight illustrated in FIG. 5 to “100” in the first processing and to “50” in the second processing for one constraint, and then causes the annealing software 31 to execute the optimization processing. Furthermore, the determination unit 22c determines the constraint that is broken even if the weight is changed as a constraint that is readily broken.

### <Example of Problem List Screen>

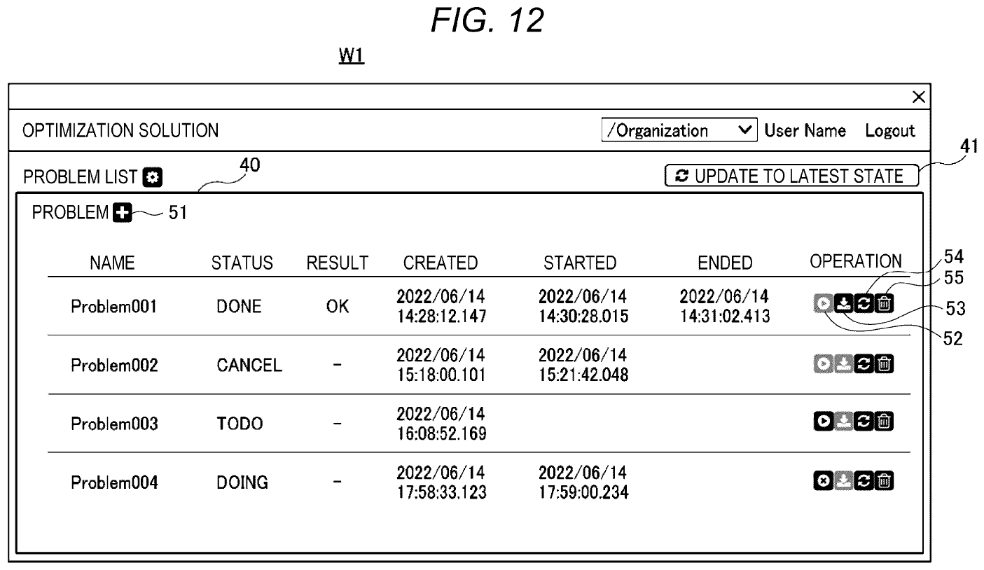

FIG. 12 is a view illustrating a configuration example of a problem list screen W1.

The problem list screen W1 is a screen that is displayed on the display by the UI unit 11 and allows the user P1 to check the contents.

The problem list screen W1 includes a problem list display unit 40 and a display update unit 41.

The problem list display unit 40 displays a list of problems input by the user P1 via the formulation apparatus 10.

The display update unit 41 is a button type operation icon that is pushed by the user P1 to update, to the latest state, contents of each item of the problem displayed on the problem list display unit 40.

In addition to an upload button 51, the problem list display unit 40 includes respective items of a name, a status, a result, created, started, ended, and operation to display problems.

The upload button 51 is used by the user P1 to make an instruction to upload the problem file.

A name of a problem input by the user P1 is displayed in the name item.

An execution status of the annealing software 31 for the input problem is indicated in the status item.

The execution result of the annealing software 31 is indicated in the result item. If the result is “OK”, this result indicates that a solution has been found. In this regard, whether or not this solution is an optimal solution is not clear. On the other hand, if the result is “−”, this result indicates that no solution is found or optimization processing is not performed. Note that, when the result is “NG”, the user P1 needs to take a measure of, for example, reconsidering the problem and inputting the corrected problem to the UI unit 11.

Dates and times at which problem models have been created by the model generation unit 23 after problems are input via the UI unit 11 are indicated in the creation item.

Dates and times at which the optimization control unit 22 has transmitted the problem model to the annealing software 31 and the annealing software 31 has started executing the problem model are indicated in the start item. As described above, the loop processing performed by the optimization control unit 22 and the annealing software 31 in cooperation is performed a plurality of times.

Dates and times at which processing of the annealing software 31 has been ended since the optimization control unit 22 has obtained the optimal solution based on the execution result of the annealing software 31 are indicated in the end item.

A status “DONE” indicates a state where the annealing software 31 has already completed execution of the optimization processing, and the optimization control unit 22 has obtained the optimal solution.

A status “CANCEL” indicates that execution of the optimization processing of the annealing software 31 has been canceled for some reason. Therefore, no value is displayed in the end item.

A status “TODO” indicates that the optimization control unit 22 and the annealing software 31 currently have completed preparation for execution of the optimization processing in cooperation now. At this time, the optimization control unit 22 stands by to input the problem model to the annealing software 31. Hence, no value is displayed in the start and end items.

A status “DOING” indicates that the problem model is being executed by the annealing software 31. Therefore, no value is displayed in the end item.

By the way, the problem model is not generated immediately after the user P1 inputs the problem, and the annealing software 31 cannot execute the optimization processing using the problem model. Hence, the problem list display unit 40 is provided with the operation item that allows the user P1 to instruct an operation per problem. Operation icons that allow the user P1 to operate each problem are displayed in this operation item. The operation icons include a request start button 52, a download button 53, a reload button 54, and a delete button 55.

The request start button 52 is a button that is used by the user P1 to request start of execution of the optimization processing of the problem that is inputted by the user P1 and for which preparation for execution has been completed. When the request start button 52 is pushed, the problem enters an execution waiting state of the annealing software 31.

The download button 53 is a button used by the user P1 to instruct downloading of optimization result data of the problem whose execution has been ended.

The reload button 54 is a button used by the user P1 to update display of a progress status of processing of a currently displayed problem. When the reload button 54 is pushed, the status item changes from “TODO” to “DOING” or “DONE”.

The delete button 55 is a button used by the user P1 to instruct deletion of each currently displayed problem.

As described above, the user P1 can check the optimization result with another PC, an application program, or the like by downloading the optimization result data. In this regard, an unillustrated optimization result check screen may be provided to enable the user P1 to check the optimization result from the screen via the UI unit 11.

In the above-described optimization control apparatus 20 according to the first embodiment, the optimization control unit 22 transmits a problem model to the annealing software 31, checks an execution result of the annealing software 31, and determines whether or not there is a constraint broken by the optimization processing. Furthermore, the optimization control unit 22 adds a weight for making the constraint difficult to be broken according to the degree of importance of the broken constraint, and causes the annealing software 31 to perform the optimization processing of the problem again. The optimization control unit 22 and the annealing software 31 can obtain a solution at which the constraint is not broken as much as possible by repeating weight adjustment and optimization processing until the target satisfaction rate (e.g., 90%) can be achieved among all constraints.

In the present embodiment, the processing where the optimization control unit 22 adds a weight to the constraint, and the optimization processing of the annealing software 31 are automatically performed. Consequently, the user P1 does not need to set adjustment of constraints and variable values that may result in an enormous number, so that it is possible to reduce a burden on the user P1 caused until a solution is obtained after a problem is input. Furthermore, a solution obtained by repeating weight adjustment and optimization processing until the target satisfaction rate (e.g., 90%) can be achieved is a solution that satisfies the constraint. Consequently, it is possible to shorten the time taken until the solution satisfying the constraint is obtained by the method according to the present embodiment compared to the time taken until the solution satisfying all constraints is obtained by the conventional method.

Furthermore, the optimization control unit 22 can detect a constraint that is readily broken at the time of the initial optimization processing, and set a weight to this constraint. Consequently, the initial optimization processing makes it possible to first create a state where the constraint is kept. Subsequently, when detecting a constraint that is readily broken or a constraint that has been broken by execution of the optimization processing, the optimization control unit 22 changes the weight only for the constraint that is readily broken or the broken constraint. Consequently, it is possible to reduce the time taken until the annealing software 31 outputs the execution result that is the optimal solution.

Note that the problem solving system 1 according to the above-described embodiment can be used not only to optimize personnel allocation at a time when work shifts are considered, but also to solve various combinatorial optimization problems such as optimization of a financial portfolio.

### Second Embodiment

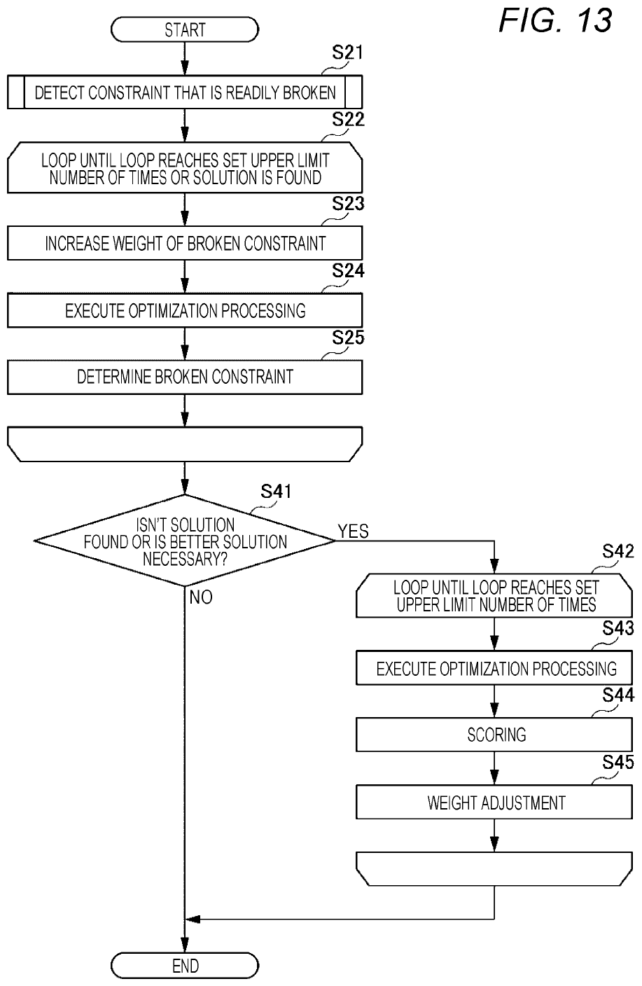

Next, processing of a problem solving system 1 according to the second embodiment of the present invention will be described with reference to FIG. 13.

According to the above-described processing according to the first embodiment, even in a case where the constraint is not satisfied or in a case where there is a demand for searching for a better solution than the found solution more, a better solution cannot be obtained in some cases by the processing of increasing a weight of the broken constraint. Hence, according to the processing according to the second embodiment, conventional automatic adjustment processing is additionally performed to obtain a much better result based on the result of the processing according to the first embodiment.

FIG. 13 is a flowchart illustrating an example of the processing of the problem solving system 1 according to the second embodiment. Since the processing in first steps S21 to S25 of the processing in FIG. 13 is the same as processing illustrated in FIG. 10, detailed description thereof will be omitted.

After the loop processing in step S22, an optimization control unit 22 may not find a solution even by repeatedly performing processing of inputting to an annealing apparatus 30 again a combinatorial optimization problem for which a weight has been changed for a broken constraint, or may request a solution better than the found solution. In this case, the optimization control unit 22 determines whether no solution is found or a better solution is necessary (S41). When the optimization control unit 22 determines that a solution has been found or that a better solution is unnecessary (NO in S41), this processing ends.

On the other hand, in a case where the optimization control unit 22 determines that no solution is found or the better solution is necessary (YES in S41), loop processing in steps S42 to S45 is executed. This processing repeats processing of executing optimization processing of the annealing apparatus 30, scoring the execution result, and changing and setting a weight until the loop processing reaches the upper limit number of times set by the optimization control unit 22.

Since the processing in steps S42 to S45 is the same as the processing in steps S12 to S15 that is the conventional optimization control processing illustrated in FIG. 9, detailed description thereof will be omitted. Furthermore, the loop processing in steps S42 to S45 is executed until the loop processing reaches the set upper limit number of times, and then this processing ends.

In a case where the solution does not satisfy the constraint and the solution is not found, or in a case where a solution better than the found solution needs to be searched for more, the above-described optimization control unit 22 according to the second embodiment performs the processing in steps S42 to S45 until the processing reaches the set upper limit targeting at all constraints. As described above, the conventional processing of obtaining a “better solution” is included in the processing according to the second embodiment, so that the optimization control unit 22 can achieve a target satisfaction rate, and achieve an object of finding a “better solution”.

Note that, as described with reference to FIG. 9, the object of the conventional loop processing in steps S12 to S15 is to obtain a solution that satisfies all constraints. However, since the conventional loop processing takes time to obtain a solution, when a solution at which an unbroken constraint achieves the target satisfaction rate is obtained by the loop processing in steps S42 to S45 of the present embodiment, the loop processing may be ended.

Note that it goes without saying that the present invention is not limited to each of the above-described embodiments, and can cover various other application examples and modifications without departing from the gist of the present invention recited in the claims.

For example, each of the above-described embodiments has specifically described the configurations of the apparatus and the system in detail to describe the present invention for ease of understanding, and do not necessarily limit the configurations to those having all the described configurations. Furthermore, part of components of the embodiment described herein can be replaced with components of the another embodiment, and the components of the another embodiment can be also added to components of still another embodiment. Furthermore, as part of the components of each embodiment, other components can be also added, deleted, or replaced.

Furthermore, each embodiment has described control lines and information lines as components that are considered to be necessary for description, and do not necessarily indicate all control lines and information lines in terms of products. Practically, it may be considered that almost all the components are connected with each other.

What is claimed is:

1. An optimization control apparatus comprising:
a database that stores a solution of an annealing apparatus that solves a combinatorial optimization problem by optimization processing that uses an annealing method; and an optimization control unit that sets a weight to a constraint of the combinatorial optimization problem, causes the annealing apparatus to execute the optimization processing, detects the constraint broken by the optimization processing based on the solution stored in the database, inputs to the annealing apparatus again the combinatorial optimization problem for which the weight for the broken constraint has been changed, repeatedly performs processing of causing the annealing apparatus to execute the optimization processing, and obtains a solution at which the constraint that is not broken achieves a target satisfaction rate.

2. The optimization control apparatus according to claim 1, wherein the optimization control unit detects the constraint that is readily broken based on a history obtained by causing the annealing apparatus to previously execute the optimization processing, and increases the weight for the constraint that is readily broken.

3. The optimization control apparatus according to claim 2, wherein the optimization control unit inputs to the annealing apparatus again the combinatorial optimization problem for which the weight has been changed, repeatedly performs the processing of causing the annealing apparatus to execute the optimization processing, and detects the constraint whose number of times that the constraint has been broken with respect to a total number of times of processing is a predetermined value or more as the constraint that is readily broken.

4. The optimization control apparatus according to claim 3, wherein the optimization control unit determines that the constraint is not broken when the solution is included between a lower limit value and an upper limit value, and determines that the constraint has been broken when the solution is not included between the lower limit value and the upper limit value.

5. The optimization control apparatus according to claim 4, wherein the optimization control unit determines an initial value of the weight based on a parameter prepared in advance.

6. The optimization control apparatus according to claim 4, wherein the optimization control unit determines an initial value of the weight based on an execution result obtained by causing the annealing apparatus to execute the optimization processing based on arbitrary settings.

7. The optimization control apparatus according to claim 4, wherein the optimization control unit determines an initial value of the weight based on an execution result obtained by causing the annealing apparatus to previously execute the optimization processing.

8. The optimization control apparatus according to claim 4, wherein the optimization control unit sets a number of times of processing of changing the weight or sets a timing to stop the processing of changing the weight.

9. The optimization control apparatus according to claim 4, wherein the optimization control unit determines a change amount of the weight per constraint based on an execution result of the optimization processing previously executed by the annealing apparatus.

10. The optimization control apparatus according to claim 4, wherein, in a case where the solution is not found even when the processing of inputting to the annealing apparatus again the combinatorial optimization problem for which the weight has been changed for the broken constraint is repeatedly performed, or in a case where a solution better than the found solution is requested, the optimization control unit repeats processing of causing the annealing apparatus to execute the optimization processing, scoring the execution result of the optimization processing, and changing and setting the weight until the processing reaches a set upper limit number of times.

11. An optimization control method comprising:
storing in a database a solution of an annealing apparatus that solves a combinatorial optimization problem by optimization processing that uses an annealing method; setting a weight to a constraint of the combinatorial optimization problem, and causing the annealing apparatus to execute the optimization processing;
detecting the constraint broken by the optimization processing based on the solution stored in the database, and changing the weight for the broken constraint; and inputting the combinatorial optimization problem to the annealing apparatus again, repeatedly performing processing of causing the annealing apparatus to execute the optimization processing, and obtaining a solution at which the constraint that is not broken achieves a target satisfaction rate.

12. A program for causing a computer to execute:
a process of storing in a database a solution of an annealing apparatus that solves a combinatorial optimization problem by optimization processing that uses an annealing method;
a process of setting a weight to a constraint of the combinatorial optimization problem, and causing the annealing apparatus to execute the optimization processing; a process of detecting the constraint broken by the optimization processing based on the solution stored in the database, and changing the weight for the broken constraint; and
a process of inputting the combinatorial optimization problem to the annealing apparatus again, repeatedly performing processing of causing the annealing apparatus to execute the optimization processing, and obtaining a solution at which the constraint that is not broken achieves a target satisfaction rate.
